SEQUENCE LISTING (105 sequences)

SEQ ID NO: 1 - protein, 558 aa, Mus musculus
MYRRLGEALLLSRAGPAALGSAAADSAALLGWARGQPSAAPQPGLTPVARRHYSEAAADREDDPNFFKMWEGFFDRGASIVEDKLVEDLKTRESEEQKRNRVRGILRIIKPCNHVLSLSFPIRRDDGSWEVIEGYRAQHSQHRTPCKGGIRYSTDVSVDEVKALASLMTYKCAVVDVPFGGAKAGVKINPKNYTDNELEKITRRFTMELAKKGFIGPGIDVPAPDMSTGEREMSWIADTYASTIGHYDINAHACVTGKPISQGGIHGRISATGRGVFHGIENFINEASYMSILGMTPGFGDKTFVVQGFGNVGLHSMRYLHRFGAKCVGVGESDGSIWNPDGIDPKELEDFKLQHGSILGFPKAKVYEGSILEADCDILIPAASEKQLTKSNAPRVKAKIIAEGANGPTTPEADKIFLERNIMVIPDLYLNAGGVTVSYFEWLKNLNHVSYGRLTFKYERDSNYHLLMSVQESLERKFGKHGGTIPVVPTAEFQDRISGASEKDIVHSGLAYTMERSARQIMRTAMKYNLGLDLRTAAYVNAIEKVFKVYNEAGVTFT

SEQ ID NO: 2 - protein, 33 aa, Artificial sequence
  Virtual sequence generated by the current invention in one embodiment
YHRLGEALLLSRAGPAALGSAAADSAALLGWAR

SEQ ID NO: 3 - protein, 49 aa, Artificial Sequence
  Virtual sequence generated by the current invention in one embodiment
YRHLGEALLLSRAGPAALGSAAADSAALLGWARGQPSAAPQPGLTPVAR

SEQ ID NO: 4 - protein, 33 aa, Artificial sequence
  Virtual sequence generated by the current invention in one embodiment
YRRLGKALLLSRAGPAALGSAAADSAALLGWAR

SEQ ID NO: 5 - protein, 50 aa, Artificial sequence
  Virtual sequence generated by the current invention in one embodiment
YRRLGEALLLSHAGPAALGSAAADSAALLGWARGQPSAAPQPGLTPVARR

SEQ ID NO: 6 - protein, 48 aa, Artificial sequence
  Virtual sequence generated by the current invention in one embodiment
RLGEALLLSRTGPAALGSAAADSAALLGWARGQPSAAPQPGLTPVARR

SEQ ID NO: 7 - protein, 47 aa, Artificial sequence
  Virtual sequence generated by the current invention in one embodiment
RLGEALLLSRARPAALGSAAADSAALLGWARGQPSAAPQPGLTPVAR

SEQ ID NO: 8 - protein, 48 aa, Artificial sequence
  Virtual sequence generated by the current invention in one embodiment
RLGEALLLSRAGPTALGSAAADSAALLGWARGQPSAAPQPGLTPVARR

SEQ ID NO: 9 - protein, 12 aa, Mus musculus
DDGSWEVIEGYR

SEQ ID NO: 10 - protein, 16 aa, Mus musculus
IIAEGANGPTTPEADK

SEQ ID NO: 11 - protein, 19 aa, Mus musculus
GFIGPGIDVPAPDMSTGER

SEQ ID NO: 12 - protein, 16 aa, Mus musculus
IIAEGANGPTTPEADK

SEQ ID NO: 13 - protein, 13 aa, Mus musculus
DIVHSGLAYTMER

SEQ ID NO: 14 - protein, 13 aa, Mus musculus
DIVHSGLAYTMER

SEQ ID NO: 15 - protein, 16 aa, Mus musculus
IIAEGANGPTTPEADK

SEQ ID NO: 16 - protein, 10 aa, Mus musculus
TAAYVNAIEK

SEQ ID NO: 17 - protein, 10 aa, Mus musculus
TAAYVNAIEK

SEQ ID NO: 18 - protein, 11 aa, Mus musculus
YSTDVSVDEVK

SEQ ID NO: 19 - protein, 8 aa, Mus musculus
YNLGLDLR

SEQ ID NO: 20 - protein, 16 aa, Mus musculus
HGGTIPVVPTAEFQDR

SEQ ID NO: 21 - protein, 8 aa, Mus musculus
MVEGFFDR

SEQ ID NO: 22 - protein, 10 aa, Mus musculus
TAAYVNAIEK

SEQ ID NO: 23 - protein, 11 aa, Mus musculus
YSTDVSVDEVK

SEQ ID NO: 24 - protein, 27 aa, Mus musculus
FTMELAKKGFIGPGIDVPAPDMSTGER

SEQ ID NO: 25 - protein, 11 aa, Mus musculus
YSTDVSVDEVK

SEQ ID NO: 26 - protein, 19 aa, Mus musculus
GFIGPGIDVPAPDMSTGER

SEQ ID NO: 27 - protein, 20 aa, Mus musculus
KGFIGPGIDVPAPDMSTGER

SEQ ID NO: 28 - protein, 16 aa, Mus musculus
DSNYHLLMSVQESLER

SEQ ID NO: 29 - protein, 20 aa, Mus musculus
KGFIGPGIDVPAPDMSTGER

SEQ ID NO: 30 - protein, 9 aa, Mus musculus
ALASLMTYK

SEQ ID NO: 31 - protein, 21 aa, Mus musculus
VYEGSILEADCDILIPAASEK

SEQ ID NO: 32 - protein, 8 aa, Mus musculus
MVEGFFDR

SEQ ID NO: 33 - protein, 8 aa, Mus musculus
YNLGLDLR

SEQ ID NO: 34 - protein, 20 aa, Mus musculus
KGFIGPGIDVPAPDMSTGER

SEQ ID NO: 35 - protein, 9 aa, Mus musculus
NLNHVSYGR

SEQ ID NO: 36 - protein, 10 aa, Mus musculus
TAAYVNAIEK

SEQ ID NO: 37 - protein, 9 aa, Mus musculus
ALASLMTYK

SEQ ID NO: 38 - protein, 8 aa, Mus musculus
GASIVEDK

SEQ ID NO: 39 - protein, 7 aa, Mus musculus
FTMELAK

SEQ ID NO: 40 - protein, 10 aa, Mus musculus
TAAYVNAIEK

SEQ ID NO: 41 - protein, 16 aa, Mus musculus
DSNYHLLMSVQESLER

SEQ ID NO: 42 - protein, 27 aa, Mus musculus
FTMELAKKGFIGPGIDVPAPDMSTGER

SEQ ID NO: 43 - protein, 10 aa, Artificial sequence
  Virtual sequence generated by the current invention in one embodiment
TAAYVDAIEK

SEQ ID NO: 44 - protein, 10 aa, Artificial sequence
  Virtual sequence generated by the current invention in one embodiment
TAAYVDAIEK

SEQ ID NO: 45 - protein, 10 aa, Artificial sequence
  Virtual sequence generated by the current invention in one embodiment
TAAYVDAIEK

SEQ ID NO: 46 - protein, 10 aa, Artificial sequence
  Virtual sequence generated by the current invention in one embodiment
TAAYVDAIEK

SEQ ID NO: 47 - protein, 21 aa, Artificial sequence
  Virtual sequence generated by the current invention in one embodiment
VYEGSILEADCDILIPAASKK

SEQ ID NO: 48 - protein, 12 aa, Artificial sequence
  Virtual sequence generated by the current invention in one embodiment
NDGSWEVIEGYR

SEQ ID NO: 49 - protein, 12 aa, Artificial sequence
  Virtual sequence generated by the current invention in one embodiment
DNGSWEVIEGYR

SEQ ID NO: 50 - protein, 12 aa, Artificial sequence
  Virtual sequence generated by the current invention in one embodiment
DDGSWEVIKGYR

SEQ ID NO: 51 - protein, 449 aa, Mus musculus
MAMQKIFAREILDSRGNPTVEVDLHTAKGRFRAAVPSGASTGIYEALELRDGDKARYLGKGVLKAVEHINKTLGPALLEKKLSVVDQEKVDKFMIELDGTENKSKFGANAILGVSLAVCKAGAAEKGVPLYRHIADLAGNPDLVLPVPAFNVINGGSHAGNKLAMQEFMILPVGASSFKEAMRIGAEVYHHLKGVIKAKYGKDATNVGDEGGFAPNILENNEALELLKTAIQAAGYPDKVVIGMDVAASEFYRNGKYDLDFKSPDDPARHISGEKLGELYKNFIQNYPVVSIEDPFDQDDWATWTSFLSGVDIQIVGDDLTVTNPKRIAQAVEKKACNCLLLKVNQIGSVTESIQACKLAQSNGWGVMVSHRSGETEDTFIADLVVGLCTGQIKTGAPCRSERLAKYNQLMRIEEALGDKAVFAGRKFRNPKAKYAMQKIFAREILDSR

SEQ ID NO: 52 - protein, 15 aa, Artificial sequence
  Virtual sequence generated by the current invention in one embodiment
MPMQKIFAREILDSR

SEQ ID NO: 53 - protein, 15 aa, Artificial sequence
  Virtual sequence generated by the current invention in one embodiment
MAVQKIFAREILDSR

SEQ ID NO: 54 - protein, 15 aa, Artificial sequence
  Virtual sequence generated by the current invention in one embodiment
MALQKIFAREILDSR

SEQ ID NO: 55 - protein, 15 aa, Artificial sequence
  Virtual sequence generated by the current invention in one embodiment
MAIQKIFAREILDSR

SEQ ID NO: 56 - protein, 15 aa, Artificial sequence
  Virtual sequence generated by the current invention in one embodiment
MAYQKIFAREILDSR

SEQ ID NO: 57 - protein, 15 aa, Artificial sequence
  Virtual sequence generated by the current invention in one embodiment
MAMEKIFAREILDSR

SEQ ID NO: 58 - protein, 15 aa, Artificial sequence
  Virtual sequence generated by the current invention in one embodiment
MAMHKIFAREILDSR

SEQ ID NO: 59 - protein, 15 aa, Artificial sequence
  This is an artificial organism
MAMNKIFAREILDSR

SEQ ID NO: 60 - protein, 15 aa, Mus musculus
VNQIGSVTESIQACK

SEQ ID NO: 61 - protein, 15 aa, Mus musculus
VNQIGSVTESIQACK

SEQ ID NO: 62 - protein, 18 aa, Mus musculus
AAVPSGASTGIYEALELR

SEQ ID NO: 63 - protein, 8 aa, Mus musculus
ACNCLLLK

SEQ ID NO: 64 - protein, 8 aa, Mus musculus
ACNCLLLK

SEQ ID NO: 65 - protein, 8 aa, Mus musculus
ACNCLLLK

SEQ ID NO: 66 - protein, 7 aa, Mus musculus
AVEHINK

SEQ ID NO: 67 - protein, 6 aa, Mus musculus
YNQLMR

SEQ ID NO: 68 - protein, 7 aa, Mus musculus
AVEHINK

SEQ ID NO: 69 - protein, 6 aa, Mus musculus
YNQLMR

SEQ ID NO: 70 - protein, 6 aa, Mus musculus
YDLDFK

SEQ ID NO: 71 - protein, 6 aa, Mus musculus
YNQLMR

SEQ ID NO: 72 - protein, 7 aa, Mus musculus
AVEHINK

SEQ ID NO: 73 - protein, 6 aa, Mus musculus
YDLDFK

SEQ ID NO: 74 - protein, 7 aa, Mus musculus
AVEHINK

SEQ ID NO: 75 - protein, 6 aa, Mus musculus
EILDSR

SEQ ID NO: 76 - protein, 6 aa, Mus musculus
EILDSR

SEQ ID NO: 77 - protein, 8 aa, Mus musculus
ACNCLLLK

SEQ ID NO: 78 - protein, 15 aa, Mus musculus
YLGKGVLKAVEHINK

SEQ ID NO: 79 - protein, 6 aa, Mus musculus
EILDSR

SEQ ID NO: 80 - protein, 14 aa, Mus musculus
VDKFMIELDGTENK

SEQ ID NO: 81 - protein, 6 aa, Mus musculus
EILDSR

SEQ ID NO: 82 - protein, 19 aa, Mus musculus
EILDSRGNPTVEVDLHTAK

SEQ ID NO: 83 - protein, 12 aa, Artificial sequence
  Virtual sequence generated by the current invention in one embodiment
KLSVVDQERVDK

SEQ ID NO: 84 - protein, 12 aa, Artificial sequence
  Virtual sequence generated by the current invention in one embodiment
KLSVVDQERVDK

SEQ ID NO: 85 - protein, 12 aa, Artificial sequence
  Virtual sequence generated by the current invention in one embodiment
KLSVVDQERVDK

SEQ ID NO: 86 - protein, 12 aa, Artificial sequence
  Virtual sequence generated by the current invention in one embodiment
KLSVVDQERVDK

SEQ ID NO: 87 - protein, 11 aa, Artificial sequence
  Virtual sequence generated by the current invention in one embodiment
LSVVDQERVDK

SEQ ID NO: 88 - protein, 12 aa, Artificial sequence
  Virtual sequence generated by the current invention in one embodiment
KLSVVDQERVDK

SEQ ID NO: 89 - protein, 11 aa, Artificial sequence
  Virtual sequence generated by the current invention in one embodiment
VMIELDGTENK

SEQ ID NO: 90 - protein, 11 aa, Artificial sequence
  Virtual sequence generated by the current invention in one embodiment
VMIELDGTENK

SEQ ID NO: 91 - protein, 11 aa, Artificial sequence
  Virtual sequence generated by the current invention in one embodiment
VMIELDGTENK

SEQ ID NO: 92 - protein, 13 aa, Artificial sequence
  Virtual sequence generated by the current invention in one embodiment
VMIELDGTENKSK

SEQ ID NO: 93 - protein, 13 aa, Artificial sequence
  Virtual sequence generated by the current invention in one embodiment
VMIELDGTENKSK

SEQ ID NO: 94 - protein, 13 aa, Artificial sequence
  Virtual sequence generated by the current invention in one embodiment
GNPTVEVDLHQAK

SEQ ID NO: 95 - protein, 13 aa, Artificial sequence
  Virtual sequence generated by the current invention in one embodiment
GNPTVEVDLHQAK

SEQ ID NO: 96 - protein, 13 aa, Artificial sequence
  Virtual sequence generated by the current invention in one embodiment
GNPTVEVDLHQAK

SEQ ID NO: 97 - protein, 13 aa, Artificial sequence
  Virtual sequence generated by the current invention in one embodiment
GNPTVEVDLHQAK

SEQ ID NO: 98 - protein, 13 aa, Artificial sequence
  Virtual sequence generated by the current invention in one embodiment
GNPTVEVDLHQAK

SEQ ID NO: 99 - protein, 12 aa, Artificial sequence
  Virtual sequence generated by the current invention in one embodiment
KLSVVDQEKVDR

SEQ ID NO: 100 - protein, 12 aa, Artificial sequence
  Virtual sequence generated by the current invention in one embodiment
KLSVVDQEKVDR

SEQ ID NO: 101 - protein, 12 aa, Artificial sequence
  Virtual sequence generated by the current invention in one embodiment
KLSVVDQEKVDR

SEQ ID NO: 102 - protein, 12 aa, Artificial sequence
  Virtual sequence generated by the current invention in one embodiment
KLSVVDQEKVDR

SEQ ID NO: 103 - protein, 12 aa, Artificial sequence
  Virtual sequence generated by the current invention in one embodiment
KLSVVDQEKVDR

SEQ ID NO: 104 - protein, 11 aa, Artificial sequence
  Virtual sequence generated by the current invention in one embodiment
LSVVDQEKVDR

SEQ ID NO: 105 - protein, 15 aa, Artificial sequence
  Virtual sequence generated by the current invention in one embodiment
VNQIGSVTESIEACK

(19) United States
(12) Patent Application Publication
(10) Pub. No.: US 2009/0210207 A1
(43) Pub. Date: Aug. 20, 2009

(54) SYSTEM AND METHOD FOR SEQUENCE VARIATION/PREDICTION AND GENETIC ENGINEERING DETECTION USING DOCUMENTED CODON/AMINO ACID MUTATION AND/OR SUBSTITUTION PATTERNS

(75) Inventors: John Andrew Keightley, Kansas City, MO (US); Gerald J. Wyckoff, Overland Park, KS (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: THE CURATORS OF THE UNIVERSITY OF MISSOURI, Columbia, MO (US)

(21) Appl. No.: 11/911,495

(22) PCT Filed: Nov. 14, 2005
(86) PCT No.: PCT/US05/41307

§ 371 Date: Oct. 17, 2008

(30) Foreign Application Priority Data
Apr. 14, 2005 (US) 60671354

(51) Int. Cl. G06G 7/58

(52) U.S. Cl. 703/11

(57) ABSTRACT

The present invention primarily relates to protein identification and can be particularly useful for bioinformaticists employing a mass spectrometry analysis. The present invention provides systems and methods to produce virtual databases, virtual database entries, or virtual amino acid sequences that can be used to improve the identification of unknown proteins and facilitate recognizing engineered proteins and distinguishing between natural and engineered genes and proteins. The present invention uses variations, such as mutation or substitution patterns, evident in and derived from known DNA, RNA, and protein sequences to predict and generate virtual DNA, RNA, and amino acid sequences that may not be represented in the current databases but that are likely to occur in nature. Substitution patterns may be derived from either the chemical, physical, and biological patterns of mutation or the derived, observable patterns of evolutionary fixation of such mutations between or within species. These virtual sequences (or databases/datafiles of such virtual sequences) contain novel, but statistically likely sequences for use in comparing to unknown proteins (peptides) for protein identification. The use of such synthetic sequences and/or databases facilitate the recognition and distinction between naturally occurring and genetically engineered DNA, RNA, and protein sequences.

### TECHNICAL FIELD

The present invention primarily relates to protein identification. The present invention provides systems and methods to produce virtual databases, virtual database entries, or virtual amino acid sequences that can be used to improve the identification of unknown proteins and facilitate recognizing engineered proteins and distinguishing between natural and engineered genes and proteins. The present invention uses variations, such as mutation or substitution patterns, evident in and derived from known DNA, RNA, and protein sequences to predict and generate virtual DNA, RNA, and amino acid sequences that may not be represented in the current databases but that are likely to occur in nature. Substitution patterns may be derived from either the chemical, physical, and biological patterns of mutation or the derived, observable patterns of evolutionary fixation of such mutations between or within species. These virtual sequences (or databases/datafiles of such synthetic sequences) contain novel, but statistically likely sequences for use in comparing to unknown proteins (peptides) for protein identification. The use of such synthetic sequences and/or databases facilitate the recognition and distinction between naturally occurring and genetically engineered DNA, RNA, and protein sequences.

### BACKGROUND OF THE INVENTION

The present invention relates to peptide and protein identification. One skilled in the art will be familiar with protein identification systems and methods that compare unknown protein mass spectrometry data with databases containing data for known proteins, including their amino acid sequence or genetic information, using search programs and related software.

Most protein identification strategies require enzymatically cutting the protein into shorter peptides. Typically, the protein is digested with an endoproteinase prior to analysis, which cleaves the protein and generates specific peptides. Although one can prepare the protein for mass spectrometry analysis by digesting it with a variety of proteinases, TRYPSIN is often chosen when preparing a protein to be analyzed using a mass spectrometer. Mass spectrometers can assist in the identification of peptides derived from proteins because they can be used to measure the mass of the intact peptides (MS), or they can be used to measure the mass of fragments that are generated from the peptide inside the mass spectrometer (MS/MS). Although one can use the intact peptide masses for protein identification (MS), a powerful and statistically persuasive strategy focuses on the measurement of the mass of the fragments of each peptide (MS/MS), because these fragments have a unique set of masses associated with the exact sequence of the peptide. One skilled in the art will recognize that mass measurement may be achieved through spectral analysis.

Capillary LC-tandem mass spectrometry is often used to generate this type of data. The term capillary LC-tandem refers to nano-scaled liquid chromatography, which can be used in small scale peptide separation for analysis by mass spectrometry. The mass spectrometer generates MS and MS/MS spectra from purified peptides as they come out of the capillary LC separation and purification system. MS/MS spectra are also referred to commonly as product ion spectra, MS2, fragmentation spectra, and other similar terms. MS/MS spectra contain the fragment mass measurements.

In the case of Matrix Assisted Laser-Desorption Ionization (MALDI) mass spectrometers, the method of separating peptides is fundamentally different from capillary chromatography, but the production of peptide mass (MS) and/or MS/MS spectra (MS/MS) is also the goal. MS/MS spectra hold the unique information for peptides and provide the basis of identification.

Currently, protein identification software implements two basic strategies. The first approach is based on the direct comparison of peptide mass spectral data (MS and/or MS/MS) to predicted peptide mass and peptide fragment masses calculated from existing known protein database entries. The fairly unique mass of the peptides, and the fairly predictable but very unique patterns of peptide fragmentation made this strategy effective because proteins often have identical peptides represented in at least one database entry to allow a match to occur. When this is prevented by the absence of the specific sequence from the database, it is necessary to interpret the unmatched spectra (manually or by computer analysis), which is often referred to as “de novo” interpretation, or de novo sequencing. De novo interpretation is the basis for all variations of the second approach.

The first approach involves the comparison of mass spectrometry data to data derived from existing database entries, which depends on the availability of existing sequences. A match that implies successful protein identification depends upon the agreement of MS and/or MS/MS data with known sequences contained in database entries.

If peptide mass only is used for the process, the mass values, which are typically represented by peaks present in a mass spectrum (MS) are compared to the masses that are calculated from the database sequences. Commercially available search programs perform a virtual endoproteinase digestion (using TRYPSIN, for example) to produce peptides from each protein entry in the database. The programs normally calculate the mass of each predicted peptide in the database and compare the resulting list of masses with the experimental data. Ensuing matches are typically presented with database entries that received the highest number of peptide mass matches first in the search results.

If both peptide mass and peptide fragment masses are to be used for comparison in the search, the commercially available computer program typically converts each MS/MS scan (product ion spectrum) contained in an experimental data file into a table of numeric values that describes the scan. Each table consists of precursor mass (presumed peptide mass) and a list of masses evident in the spectrum (the fragment masses). This collection of numeric values is unique for each peptide, which forms the basis of the identification. From known database entries, commercially available programs can calculate the peptide mass (precursor mass) and the mass of the predicted fragments to generate a similar table for each peptide in the database. Once the list of tables describing the scans in the data and the list of tables describing the database entries are prepared, the program can compare two sets of tables and score the best matches to identify the protein or proteins in the sample.

Each additional separate peptide match present in a given protein entry increases the quality and strength of a protein identification, for that entry, but if identification is based on one or few matches, the identification is typically considered candidates to be only tentative. Therefore, it is important to maximize the number of matches in this process to gain confidence in the legitimate identification of a protein.

This strategy of protein identification based on comparing product ion spectra or the data represented by the spectra, to the calculated or virtual product ion spectra based on database entries is phenomenally productive due to the unique nature of product ion spectra for a given peptide. However, if the peptide sequence present in the sample is not represented by at least one entry in the database, no exact match can occur. Furthermore, when only one or few exact sequence matches can be made, the identification can be statistically weak. The absence of a sequence from the database can be caused by a variety of factors, including species variation or evolutionary fixation, mutation or polymorphism within a species, the existence of a novel splice form that has not been characterized, database errors, and/or RNA editing that changes the original DNA code represented in the database. The absence of sequences from existing databases, for whatever reason, presents a significant obstacle to protein identification.

Existing protein database search programs, such as “Sequest,” by Thermo Finnigan; “Mascot,” by Matrix Science; “Spectrum Mill,” by Agilent; “Protein Lynx,” by Micromass, Waters; and “Pro ID,” by Applied Biosystems may offer methods to try to increase the number of peptide matches and improve statistically weak protein identifications. Existing programs may compare data, such as data from unmatched MS/MS spectra, to the existing tentatively-identified protein with optional amino acid mass adjustments to account for potential modifications. One skilled in the art will recognize this as modification searching or searching with modifications. Existing search programs may also compare the data while allowing amino acid changes in the existing tentatively-identified protein from a fixed set of allowable differences or may allow fully random amino acid changes, assuming all changes are equally likely.

If a sequence is not represented in the database, existing programs may utilize de novo interpretation to determine a sequence from unassigned scans. De novo interpretation is not a database search, but rather a method of accounting for spectral peaks to yield a mathematically acceptable solution to account for spectral peaks, based on amino acid masses. However, typical peptide MS/MS spectra are incomplete, often missing fragment peaks. Consequently, de novo interpretation of an MS/MS spectrum rarely yields more than a partial sequence or “sequence tag.” Existing software, such as BLAST, can use sequence tags to find potential parts of an existing candidate protein match to employ other methods that may enhance identification. Such methods, however, still match short sequences to existing database entries. Moreover, de novo interpretation often leads to numerically compatible but biologically incorrect interpretations. Error tolerant searching, as implemented in Matrix Science's “Mascot” and Thermo Electron Corporation's SALSA program depend significantly on a numerical compliance. Therefore, de novo spectral interpretation often suggests sequences that may not support biological function.

Although existing approaches successfully identify many proteins, they do not incorporate recognizable patterns emerging from analyses of existing sequence databases. For example, the comparison of existing, related database entries allows a knowledgeable bioinformaticist to identify substitution patterns of mutation or evolutionary fixation. These substitution patterns, which originate in nucleotide sequences (DNA and RNA sequences) result in statistically predictable amino acid variation patterns in the proteins that they encode. Based on these patterns, it is possible to predict substitutions with remarkable success. When the substitutions do not significantly impair normal protein functions, they are referred to as polymorphisms. When substitutions do impair protein function, they are typically referred to as mutations. When substitutions survive for generations and become established, they have been subjected to natural section and are referred to as fixation events. Still other mutations result in gaps or inserts in sequences. Here, all of these substitutions, gaps, or inserts are generically referred to as variations. By inflicting statistically likely amino acid variations on existing protein sequence entries based on these mutation and/or substitution patterns, it is possible to generate virtual variations, such as polymorphisms, that predict the actual occurrence of real variations in living organisms, with astonishing success.

The present invention can create biologically-relevant, novel sequences that can be incorporated into a database to match otherwise unassignable data. The present invention avoids the inherent numerical bias of de novo interpretive approaches by providing protein identification programs with statistically likely and/or evolutionarily informed virtual variations of sequences in searchable format. Importantly, the present invention can be used to generate novel, biologically sensible virtual database entries, allowing the search programs to identify spectral matches. Accordingly, the present invention does not rely on potentially error prone spectral interpretation as a starting point. In accordance with the present invention, tools based on this technology may allow one skilled in the art to apply the current invention to identify unknown proteins more accurately, with better confidence, to achieve a higher success rate.

### SUMMARY OF THE INVENTION

The present invention provides systems and methods for producing sequence databases with virtual variations that substantially increase the efficiency of protein identification methods and that allow for the recognition and distinction between likely, naturally predictable protein sequences and genetically engineered protein sequences. Specifically, the present invention allows for the generation of biologically predictable variations of existing sequences to produce novel sequences that are not presently represented in standard databases but are likely to occur in nature.

Experimentally obtained spectral data may be compared to the virtually predicted spectral characteristics of the virtual sequences using existing protein identification programs, resulting in new matches. Therefore, the present invention may be used to improve the success or confidence of unknown protein identification by allowing otherwise unmatched spectra to be matched with novel entries in a virtual database generated by the present invention.

Systems and methods in accordance with the present invention may be used in a variety of ways to identify numerous types of unknown proteins. While some of these variations are described in greater detail below, one skilled in the art will appreciate that these descriptions are exemplary only and do not in any way limit the present invention.

### BRIEF DESCRIPTION OF THE DRAWING

FIG. 1 is a block diagram of one embodiment of the present invention, wherein the variation is made at the nucleotide level.

FIG. 2 is a block diagram of one embodiment of the present invention, wherein the variation is made at the amino acid level.

FIG. 3 is a block diagram of one embodiment of the present invention, wherein the variation is made at the nucleotide level in a different manner than that shown in FIG. 1.

FIG. 4 is a block diagram of one embodiment of the present invention, wherein the variation is made at the amino acid level in a different manner than that shown in FIG. 2.

FIG. 5 displays an abbreviated, annotated output example of one embodiment of the present invention, which was used to analyze mouse glutamate dehydrogenase protein.

FIG. 6 shows one way in which the virtually produced database displayed in FIG. 5 may be searched by commercially available searching programs (Sequest, in this example).

FIGS. 7a and 7b compare the NCBI known sequence match with a successful scan match to a virtual sequence generated by the current invention using the example depicted in FIG. 5.

FIGS. 8a and 8b compare the low mass range from the scans shown in FIG. 7.

FIGS. 9a and 9b compare the high mass range from the scans shown in FIG. 7.

FIG. 10 displays an abbreviated, annotated output example of one embodiment of the present invention, which was used to analyze a mouse enolase 3 amino acid sequence.

FIG. 11 shows one way in which the virtually produced database displayed in FIG. 10 may be searched by commercially available searching programs (Sequest, in this example).

FIG. 12 shows an example of how the present invention can be used to match a previously unmatched sample, based on a virtual sequence employing a phenylalanine to valine (F to V) substitution.

FIG. 13 demonstrates one way in which an embodiment of the present invention can be used to detect genetically engineered sequences.

FIG. 14 demonstrates one way in which an embodiment of the present invention can be used to detect genetically engineered sequences.

### DETAILED DESCRIPTION OF THE INVENTION

The current invention utilizes general substitution scoring matrices and statistically and/or evolutionarily informed methods to produce virtual variations, such as polymorphisms, and novel DNA, RNA, and protein sequences that can be used to recognize and identify unknown proteins and genetically-engineered mutations. Matrices can be n-dimensional, meaning they can contain any number of statistically and/or evolutionary informed variables for weighting virtual variations. Thus, multiple types of information can be utilized at the same time. The current invention prepares novel, virtual amino acid sequences and/or novel database entries that are compatible with the existing database analysis programs.

The present invention provides a method that uses statistical scoring or weighting of DNA (or RNA and resulting protein sequence) mutation and/or evolutionary fixation frequencies to predict the natural occurrence of sequences that are not in the database. Variation prediction at the nucleotide level may be based not only on single nucleotide transition and transversion rates, but also on contextual information at the di-nucleotide, codon, and amino acid level including CpG islands, codon usage, codon exchange rates, amino-acid biochemical similarity, general amino-acid exchangeability, (biochemical or evolutionarily derived) and site-specific amino acid exchangeability (biochemical or evolutionarily derived). The present invention may also utilize scoring matrices, as are well-known in the art of evolutionary biology. These so-called, scoring matrices describe observed substitution rates or frequencies seen in multiple alignments of nucleic acid or amino acid sequences. The scoring matrix assigns a score to every possible amino acid identity or substitution based on the observed frequencies of such occurrences in alignments of related proteins. Common examples well-known in the art include PAM matrices, and BLOSUM matrices, and Position-Specific Scoring Matricies (PSSM). These scoring matrices can be combined to form n-dimensional matrices which include multiple types of scoring information. These scoring matrices are also useful as substitution matrices, since they define the rates of amino acid substitution. These matrices may be referred to as substitution matrices in this document.

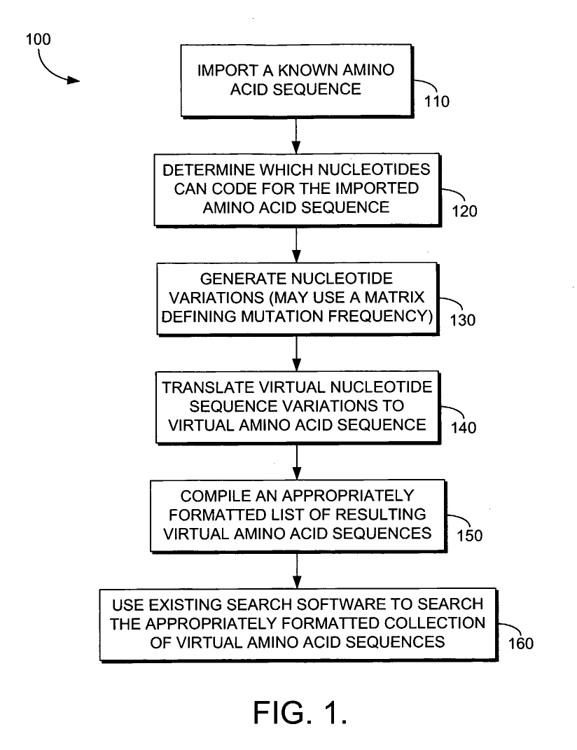

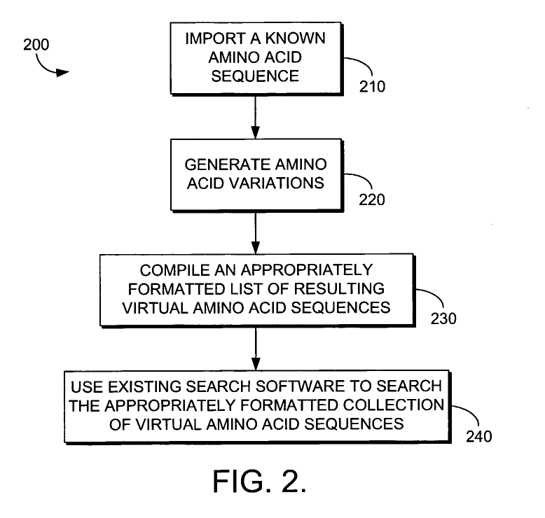

Notably, this non-random, statistically and evolutionarily weighted variation method may be employed at the nucleic acid level, as shown in FIG. 1 for example, or at the amino acid level, as shown in FIG. 2 for example. However, when amino acid variation is used, nucleotide variation is inherently behind these variations because the amino acid sequence of proteins is encoded in the DNA. The present invention may be applied to peptide only data, in the absence of nucleotide sequence, either by averaging over potential codon mutation frequencies or by applying only those mutation and fixation rules for the amino acid level, as is shown in FIG. 2. There are situations when a user may prefer to choose certain nucleotide variation types or may prefer to use amino acid variation, based on the experimental problem at hand. When using nucleotide sequences to generate the virtual sequence, mutation or fixation prediction at the nucleotide level may then be translated to corresponding amino acid sequences, thereby generating novel protein sequences that are statistically likely to be expressed in living creatures. When the novel sequences with virtual variations are used as a novel database entries to search against the MS/MS data by existing protein identification programs, the new set of statistically favorable sequences provide a statistically improved opportunity for matching against the data. Since output for amino acid changes may be in FASTA format, the virtual database may be analyzed with existing automated search programs.

By providing novel sequences in a database format acceptable for input to all major search programs, the present invention can be used by anyone that uses mass spectrometry to identify proteins. The virtual database entries generated contain statistically or evolutionarily likely sequences that may not currently exist in the databases, thereby allowing for the reconciliation of otherwise unassigned scans generated from MS/MS data. In addition, searching peptide mass only data (MS) is also possible, because the programs that search peptide mass only data also can use FASTA formatted databases to search against. Virtual databases created by the invention are therefore fully compatible with peptide mass only search strategies.

For marginal identifications of statistically low quality based on few spectra from searches using the existing databases containing known sequences, new matches generated from virtual database entries provide additional strength to protein identifications, rescuing otherwise unproductive data. Notably, a few existing programs actually implement a random substitution approach that disregards statistical or evolutionary patterns evident in the analysis of existing entries. Some existing programs employ fixed substitution matrices that assume all point mutations are equally likely to occur, which do not account for statistical or evolutionary weighted data. In these existing programs, the matrices are not user definable or selectable, and they are not utilized to generate new database entries.

In contrast, the present invention allows the choice of substitution or scoring matrix or other variation as well as the option of adjusting variation depth, which can vary the amount of allowed substitution by allowing the selection of a cut-off value at which substitution is allowed or disallowed for variations defined by a given matrix. Stated differently, the present invention is able to utilize matrices that assign non-uniform sequence variation probabilities, based on existing biologically-relevant data. The present invention not only allows the selection of user-definable, non-fixed matrices, but it also allows the user to define a variation threshold, which selects the resulting variation depth. By selecting a variation depth, the user can select the threshold probability such that any probability of variation in the selected substitution matrix not within the variation depth is not considered by the present invention. A user of the present invention can control the variation depth, taken from any chosen matrix, to generate a level of sequence variation precisely appropriate for the application or problem at hand. Thus, a user of the present invention can control the variation depth to assure that that only the most likely or least likely sequence variations in a substitution or scoring matrix are used for a particular application. Moreover, the present invention can create statistically-weighted, biologically-relevant virtual sequences, which can be utilized as virtual database entries. Accordingly, virtual database entries created by the current invention can be engineered to be both smaller and biologically more relevant than existing programs and can be tailored to the needs of the user based on the problem at hand. This not only enhances predicted success rate but also substantially reduces the processing power required for each search. One additional consequence of user-controllable variation and the resulting potentially smaller database size is that repetitive or iterative variation can be used to generate biologically likely multiple variations in each engineered virtual peptide, without producing an untenably large database. Optional multiple variations, selectively engineered into virtual peptides may be particularly useful when crossing wider evolutionary distances or searching for peptide matches in divergent species. These factors may allow an individual to identify more proteins, with more confidence, much faster.

One embodiment of the invention is shown in FIG. 1. To improve a marginal match made on the basis of an existing database entry, the user of the invention might obtain the amino acid sequence of a marginally identified protein from an existing database, as shown in method 100. The amino acid sequence is entered or otherwise imported into the present invention, as is shown in step 110 of FIG. 1. One possible source for the known input sequence might be the Entrez protein database found at the National Center for Biotechnology Information (NCBI) home page (http://www.ncbi.nlm.nih.gov/). NCBI entries are mostly derived from naturally occurring proteins or DNA sequences that occur in nature. It should be noted, however, that the “known sequence” to be used as input (for this embodiment, as well as others) need not be an existing database entry but could also include other sources, such as a consensus sequence, a user defined sequence, a partially substituted sequence, or a sequence that results from applying the present invention in an iterative manner. In this particular embodiment, the present invention takes a known sequence and determines possible nucleotide sequences that code for the known amino acid sequence (step 120 in FIG. 1). One embodiment of the present invention introduces amino acid variations into the input sequence based on scoring matrices that summarize mutation and/or evolutionary fixation frequency data for the nucleotides, as shown in FIG. 1, step. 130. The type of mutation, substitution matrix, or other variation desired to be imposed depends on the source of the sample and the users choices. If desired, the user may implement multiple substitutions per database entry. Once the virtual amino acid sequences are generated, as is shown in step 140 of FIG. 1, they may be formatted and imported into an existing database or they may form an entirely new database, as is shown in FIG. 1, step 150. These virtual database entries can be searched by existing software for comparison to observed data, as shown in FIG. 1, step 160.

Another embodiment of the invention is shown in FIG. 2, which illustrates another method 200 to improve a marginal match made on the basis of an existing database entry. The user of the invention might obtain the amino acid sequence of a marginally identified protein from an existing database, as shown as step 210 in FIG. 1. The amino acid sequence is entered or otherwise imported into the present invention. Again, the known input sequence might be the Entrez protein database found at the National Center for Biotechnology Information (NCBI) home page (http://www.ncbi.nlm.nih.gov/). The input sequence could also be a consensus or user defined sequence rather than an existing database entry, as described above. In this particular embodiment, the present invention introduces amino acid variations into the input sequence based on scoring matrices that summarize mutation and/or evolutionary fixation frequency data for the amino acids, as shown in FIG. 2, step. 220. The type of mutation, scoring matrix, or other substitution desired to be imposed depends on the source of the sample and the users choices. Once the virtual amino acid sequences are generated, they may be formatted and imported into an existing database or they may form an entirely new database, as is shown in FIG. 2, step 230. These virtual database entries can be searched by existing software for comparison to observed data, as shown in FIG. 2, step 240.

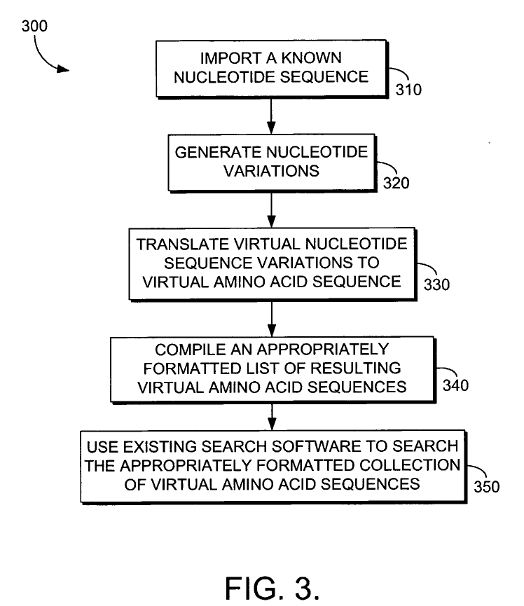

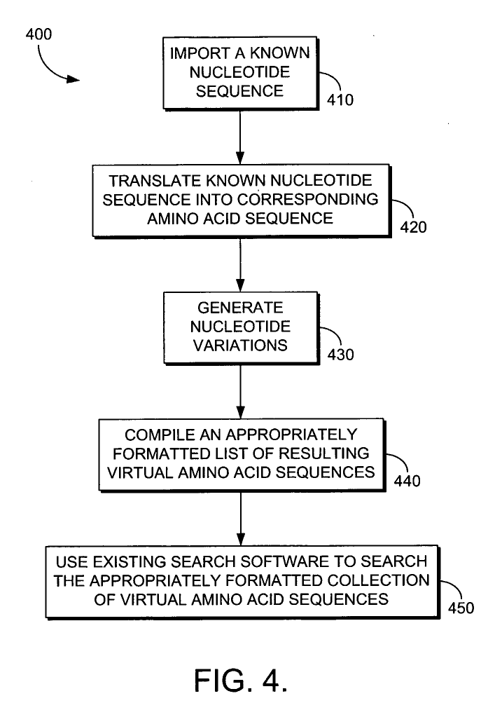

If the user chooses to start with a nucleotide sequence instead of an amino acid sequence, the user could utilize one of the embodiments described in FIGS. 3 and 4. In an embodiment of the invention, described in FIG. 3, the user could follow the link in a protein database entry, such as NCBI, to find the gene entry associated with the protein entry for use with method 300. From the nucleotide sequence database entry, the user could obtain the nucleotide reading frame that encodes the amino acid sequence and enter that reading frame sequence into the invention's sequence entry field, as shown in FIG. 3, step 310. Mutation prediction at the DNA level may be based not only on single nucleotide transition and transversion rates, but also on contextual information at the di-nucleotide, codon, and amino acid level including CpG islands, codon usage, codon exchange rates, amino-acid biochemical similarity, general amino-acid exchangeability (from evolutionary or biochemical sources), and site-specific amino acid exchangeability (from evolutionary or biochemical sources). The present invention can introduce nucleotide variations into the input, known sequence based on scoring matrices that summarize mutation and/or evolutionary fixation frequency data for the nucleotides, as shown in FIG. 3, step. 320. The type of mutation, scoring matrix, or other substitution desired to be imposed depends on the source of the sample and the users choices. The virtual nucleotide sequence is then translated to its corresponding virtual amino acid sequence, as shown in FIG. 3, step 330. Once the virtual amino acid sequences are determined, they may be formatted and imported into an existing database or they may form an entirely new database, as is shown in FIG. 3, step 340. These virtual database entries can be searched by existing software for comparison to observed data, as shown in FIG. 3, step 350.

In another embodiment of the invention, described in FIG. 4, the user could follow the link in a protein database entry, such as NCBI, to find the gene entry associated with the protein entry for use with method 400. From the nucleotide sequence database entry, the user could obtain the nucleotide reading frame that encodes the amino acid sequence and enter that reading frame sequence into the invention's sequence entry field, as shown in FIG. 4, step 410. The input nucleotide sequence is then translated to its corresponding amino acid sequence, as shown in FIG. 4, step 420. In this particular embodiment, the present invention introduces amino acid variations into the input sequence based on scoring matrices that summarize mutation and/or evolutionary fixation frequency data, as shown in FIG. 4, step. 430. The type of mutation, scoring matrix, substitution or other biologically-relevant variation desired to be imposed depends on the source of the sample and the users choices, and need not be based on a scoring matrix. Once the virtual amino acid sequences are generated, they may be formatted and imported into an existing database or they may form an entirely new database, as is shown in FIG. 4, step 440. These virtual database entries can be searched by existing software for comparison to observed data, as shown in FIG. 4, step 450.

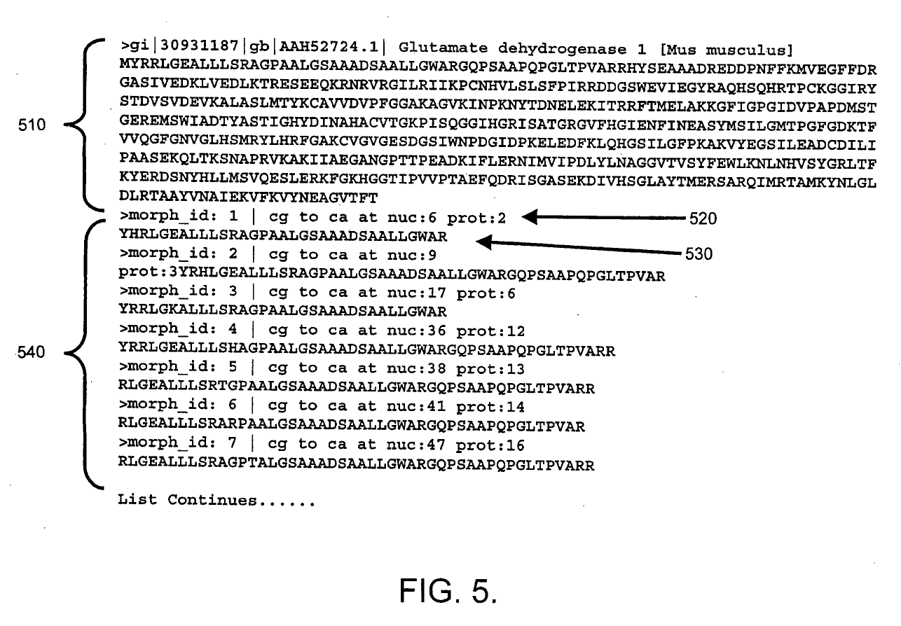

In one embodiment of the present invention for identifying a peptide in glutamate dehydrogenase protein mass spectrometry (MS) data, a simple cg to ca virtual variation is inflicted on a mouse glutamate dehydrogenase gene sequence for comparison to rat MS data. One skilled in the art will recognize the cg to ca mutation appropriate for this sample in this embodiment as a fairly prevalent DNA mutation, which causes changes in amino acid sequence in the resulting protein. This embodiment for analyzing rat glutamate dehydrogenase protein is detailed in the FIGS. 5-9. Once the chosen type of variations are made, the present invention can translate the novel DNA sequence into an amino acid sequence (step 130 in FIG. 1 or step 330 in FIG. 3). Since the available search programs process the protein sequence by executing a virtual enzyme digestion to produce peptides on database entries, native amino acid sequence from the database reference sequence surrounding the substitution is extended in both directions to produce the virtual amino acid sequences, and FASTA formatted entries are generated for each virtual sequence to precisely describe the substitution (e.g. step 140 in FIG. 1). In the example shown in FIG. 5, the present invention extended the sequence in both directions outward from the mutation to incorporate two sites recognized by the endoproteinase TRYPSIN. TRYPSIN recognizes “R” and “K”; therefore, the sequence is extended to include at least two R or K residues in both directions. This step will depend on the enzyme chosen by the user. This strategy will be recognized by one of ordinary skill in the art as necessary to represent a necessary minimum sequence to generate peptides for comparison in the searching process. Once completed, the FASTA formatted results can be used by existing search programs to find matches in the virtual sequences.

All of the standard steps that the existing search programs execute (virtual digestion, preparation of fragmentation information, etc.), may be done by the existing search software with the virtual database, just as it would on any existing native or consensus sequence database. If desired, more than one mutation per known sequence can be inflicted. This could be particularly useful when crossing into more distant species, where protein sequences are well known in the art to have more sequence differences. Importantly, this will increase the success rate in identifying unknown proteins from species known to be more genetically distant from the majority of sequences in the standard databases. It must also be recognized that, for those with multiple node computer systems engineered for brute force computational power, larger virtual databases with thousands of entries created by the present invention can be searched.

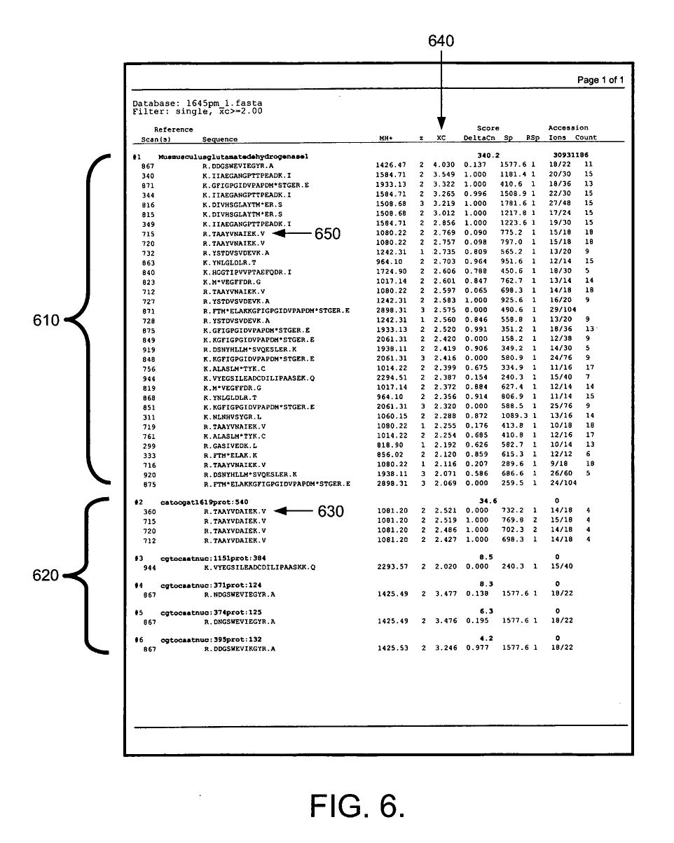

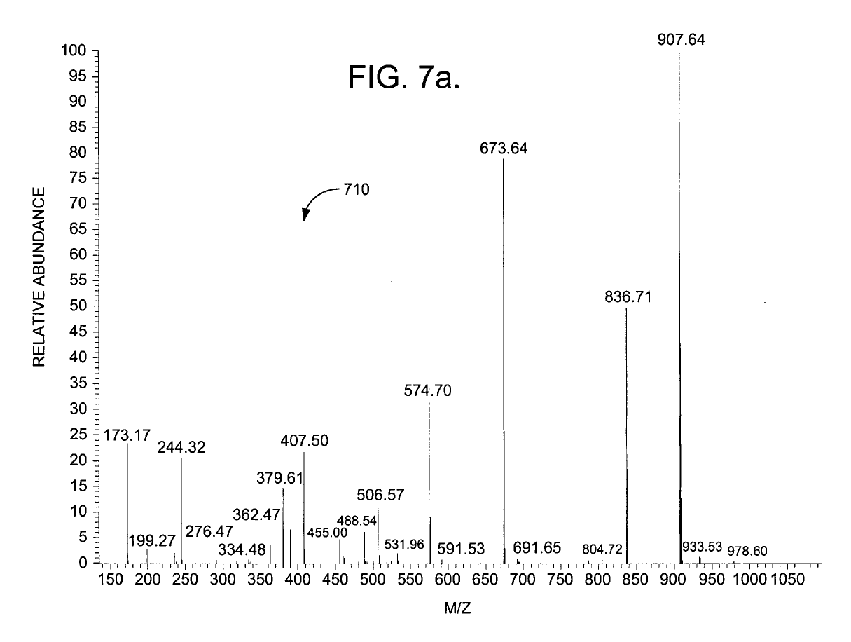

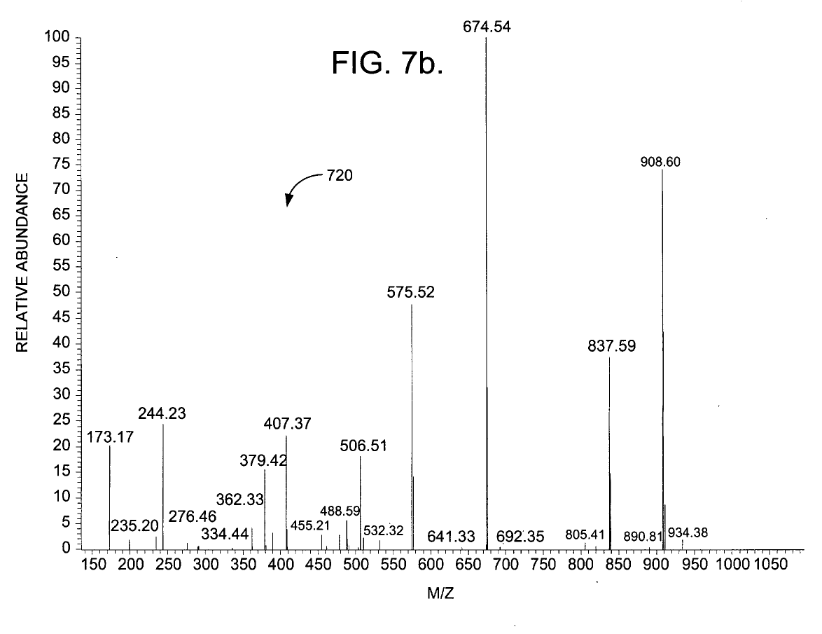

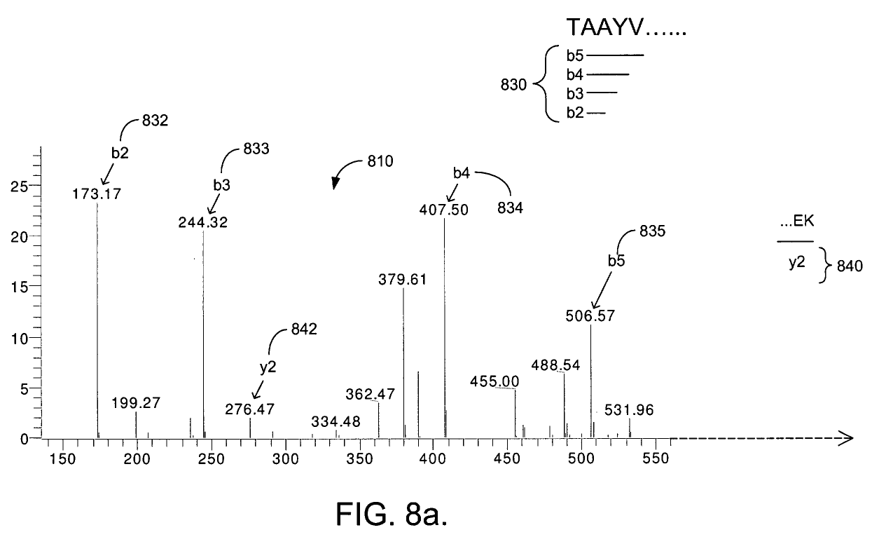

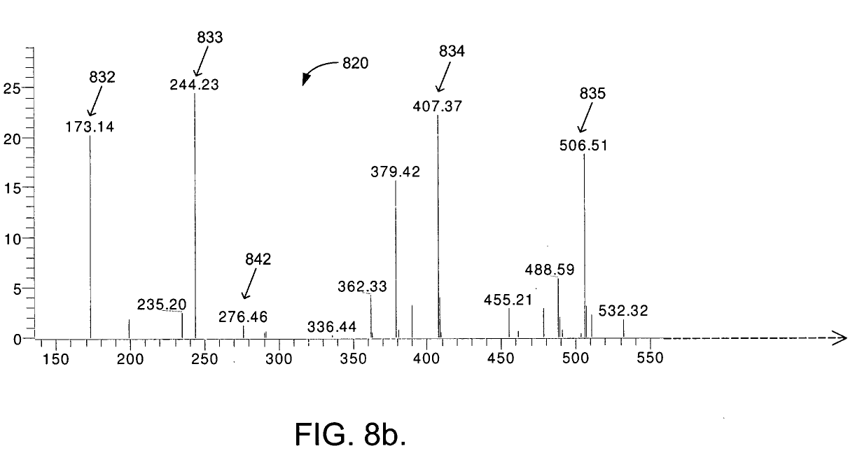

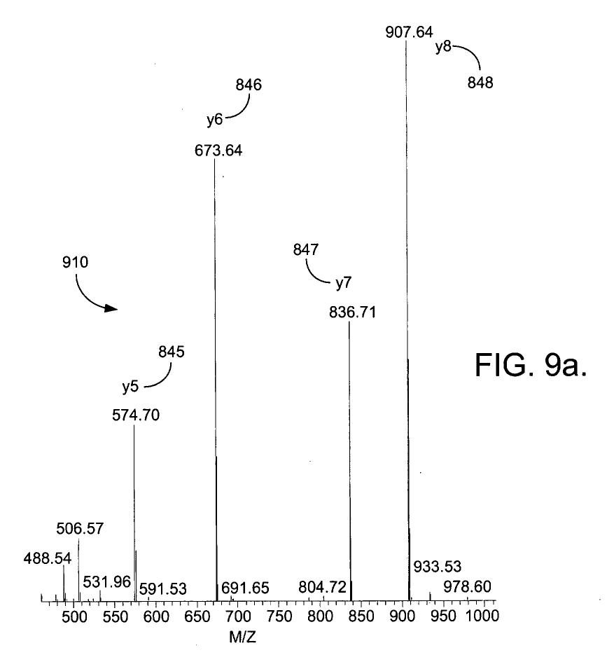

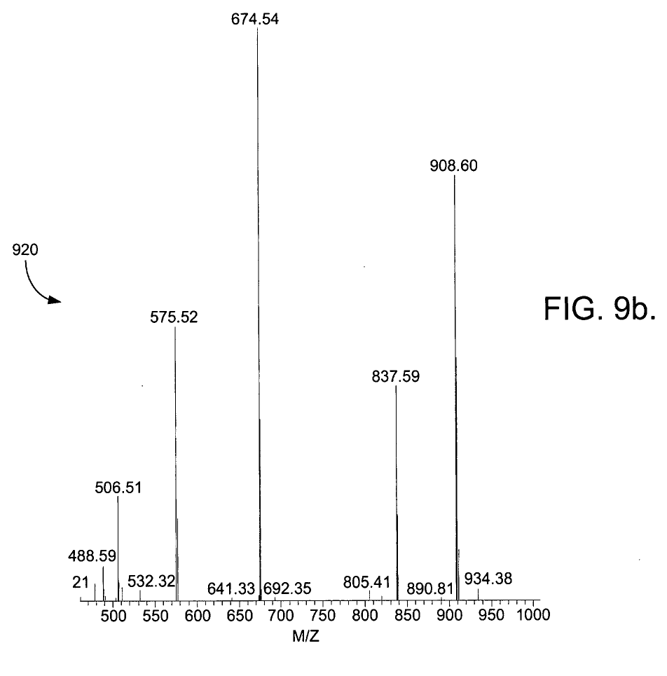

Turning now to FIGS. 5-8, beginning with FIG. 5, an example of the resulting virtual sequences 540 generated by the current invention in one embodiment for the mouse glutamate dehydrogenase DNA sequence is shown. In the example output generated by one embodiment shown in FIG. 5, the output displays the known sequence 510, which was found in the NCBI database for this example and entered into the present invention. Notably, the present invention can also show a variation description 520 and a resulting amino acid sequence 530 in the output. For this embodiment, the resulting virtual sequences 540 (only a few of which are shown in FIG. 5) are FASTA formatted for use as a searchable database by a commercially available searching program like Sequest, as is shown in the search output results in FIG. 6. Since the virtual database can be presented in a compatible search format, the commercially-available program can search and score the virtual sequence matches 620 with the same statistical scoring methods that are applied to existing database sequences that match 610 the known sequence (here, from the NCBI database). This is illustrated in the third vertical column 640 in FIG. 6, where the commercially-available program assigns a score to indicate the quality of the matched virtual sequences 620, as it would with any database entry. Thus, search programs like Sequest can treat virtual database entries exactly as it would an existing reference sequence from NCBI. Notably, the search program generated a new match 630, based on one of the virtual sequences 620, named scan #360, generated by the present invention. FIGS. 7a and 7b show the spectra 710 and 720 representing the data in sequences 650 and 630, respectively. The sample at issue matched to data representing sequence 650, represented by spectrum 710 in FIG. 7a. FIG. 7b, which contains a spectrum 720 representing the data in a virtual sequence generated by the present invention 630, shows a match previously unavailable. FIG. 8a depicts the lower mass range spectrum 810 of spectrum 710, which corresponds to sequence 650. Likewise, FIG. 8b depicts the lower mass range spectrum 820 of spectrum 720, which corresponds to virtual sequence 630. Notably, lower mass range spectra 810 and 820 are substantially similar before and after the virtually-imposed mutation (N to D) because so-called “b-ions” 830 predominate in this lower mass range, and the mass of the b2 832, b3 833, b4 834, and b5 835 fragments are unchanged by the mutation. y2 842 is also unchanged and present at this low mass range. More importantly, as is shown in FIGS. 9a and 9b, the high mass range in the two spectra, where the so-called y-ions predominate, show that the y-series y5 845, y6 846, y7 847, and y8 848 are one unit higher in mass in the high mass range of scan #360 920, as compared to scan #715 910, and thus account for the one unit mass difference between N and D, which accounts for the difference between the existing database sequence 650 (TAAYVNAIEK) and the virtual database sequence 630 generated by the present invention (TAAYVDAIEK). In this case, the invention unexpectedly identified an allelic polymorphism. This rat has both alleles for this gene (heterozygous for this polymorphism site), with both sequences occurring in the same organism. This result demonstrates the significant advantage that searching with virtual databases generated by the present invention can offer.

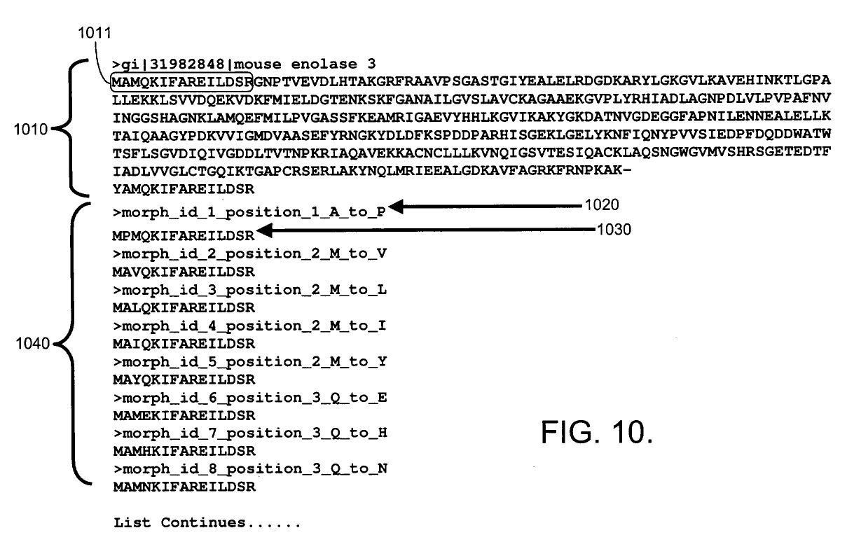

In one embodiment of the present invention for identifying a peptide in frog enolase 3 protein mass spectrometry (MS) data, a virtual variation is inflicted on an existing mouse enolase 3 amino sequence for comparison to frog MS data. This particular embodiment for analyzing frog enolase 3 protein is detailed in FIGS. 10-12.

The invention employs amino acid substitution in this embodiment based on an amino acid substitution matrix, which makes one substitution per database entry. The first portion of the resulting virtual sequences 1040 are presented in the example shown in FIG. 10. In this embodiment of the invention, the resulting database has data representing the first portion 1011 of the known sequence 1010 as the first entry in the database, followed by the single substituted resulting virtual sequences 1040. Although the substitution continues throughout the known amino acid sequence 1010, only the first eight virtual entries are shown in FIG. 10 for brevity. The present invention can show the variation description 1020 corresponding to each resulting virtual amino acid sequence 1030. Since the available search programs process each amino sequence entry by executing a virtual enzyme digestion to produce peptides, the known amino acid sequence 1010 from the database reference sequence surrounding the substitution is extended in both directions to produce the virtual amino acid sequences in the context of the reference entry, and FASTA formatted description lines 1020 are generated for each virtual sequence to precisely describe the substitution. In the example shown in FIG. 10, the present invention extended the sequence in both directions outward from the substitution to incorporate two sites recognized by the endoproteinase TRYPSIN. Note that, in the embodiment of the invention depicted in FIG. 10, an extension to the left of an imposed variation appears after the imposed variation proceeds past the selected endoproteinase site. This strategy will be recognized by one of ordinary skill in the art as necessary to represent a necessary minimum sequence to generate peptides for comparison in the searching process. Once completed, the FASTA formatted results can be used by existing search programs to find matches in the virtual sequences 1040.

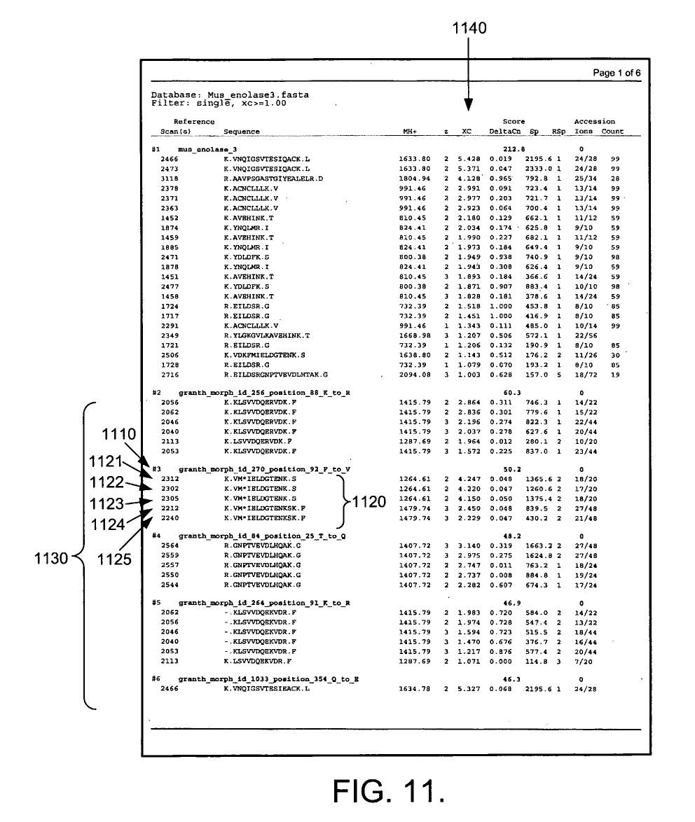

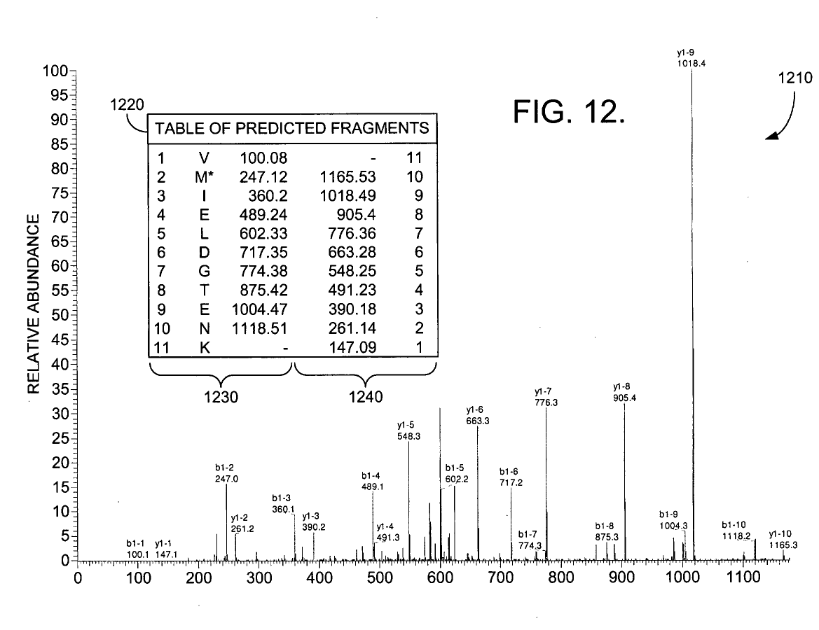

Turning now to FIG. 11, a variation description line (e.g. variation description 1020) can be preserved in the search results 1110, showing the precise substitution that allowed a new MS/MS spectral matches 1120. Variation description 1110 shows a virtual peptide that was matched to three scans 1121, 1122, 1123 in the data file. The first matched scan (scan #2312) 1121 is shown in FIG. 12 as an example of a new matching spectral scan. The virtual database can be presented as a list of standard separate searchable sequences, just as a database of naturally occurring, existing database sequences would be presented. Accordingly, search programs can search and score the matches with the same statistical scoring methods that are applied to the known, existing database entries. The third data comparison column 1140 in FIG. 11 illustrates a way in which a search program could assign a score to indicate the quality of the match with the virtual entry 1130, just as it would with any database entry. Variation description 1110 in FIG. 11 highlights one example of a virtual peptide variation that was matched to a particular unknown sample. The peptide “VM*IELDGTENK” was assigned a high score for three scans 1121, 1122, 1123 (scans #2312, #2302, and #2305, respectively).

These three scans 1121, 1122, 1123 were not matched by the search program for any peptide in the known mouse enolase 3 sequence but were found to match a virtual peptide generated by the current invention by changing phenylalanine to valine (F to V). Moreover, two additional scans 1124, 1125 (scans #2212 and #2240, respectively) were matched to a longer virtual TRYPSIN peptide (VM*IELDGTENKSK) derived from the same virtual database entry. These matched scans represent an example of successful virtual sequence substitution of prediction made by the current invention (F to V in this case), generating matches to frog sample data, out of a virtual database generated from a mouse sequence. One skilled in the art of mass spectrometry will notice that other matches are visible in FIG. 11.

FIG. 12 shows one of the mass spectra (scan #2312) 1210 from the frog data that matched to virtual peptide VM*IELDGTENK 1121, despite being previously unassigned in the frog data. One skilled in the art will recognize FIG. 12 as an excellent match for this previously unassigned spectrum. One embodiment of the present invention implemented a virtual “F” to “V” substitution 1110. Notably, the asterisk (*) appearing after the M (Methionine) in the virtual sequence 1121 in the search output shown in FIG. 12 denotes an oxidation event that affected the peptide. The fragments in the FIG. 12 spectrum 1210 correspond with the predicted values in the table 1220 calculated by the search program, also shown in FIG. 12. One skilled in the art will recognize that the “b” fragments 1230 include the first amino acid (“V”) in virtual sequence 1121 and that the “y” fragments 1240 include the last amino acid (“K”) in virtual sequence 1121. Thus, one skilled in the art will recognize both that the commercially-available program can match the virtual peptide(s) and account for previously unmatched scans, and that it can do so using an existing modification searching capability that is present in existing search programs. By presenting the search program with biologically reasonable, rationally engineered virtual database sequence entries, the current invention allows existing search programs to match unassigned spectra efficiently.

All of the standard steps that the existing search programs execute (virtual digestion, preparation of fragmentation information, etc.), may be done by the existing search software with a virtual database formed by resulting virtual sequences, just as it would on any existing database. If desired, more than one substitution or other variation per database entry can be inflicted. Multiple variations would be particularly useful when crossing into more distant species, where protein sequences are well known in the art to have more sequence differences. Importantly, this will increase the success rate in identifying unknown proteins from species known to be more genetically distant from the majority of sequences in the standard databases.

In an alternative embodiment to improve marginal matches, the user may prefer to use DNA mutation rather than amino acid substitution to inflict variations and generate a virtual variation. To accomplish this, the user would find the gene entry associated with the protein entry that was marginally identified while searching existing databases. The user might obtain the gene entry by following the appropriate link to the gene entry listed in the header of the protein entry representing the marginally identified protein. The nucleotide reading frame that encodes the amino acid sequence would be entered into the present invention, such as in a sequence entry field. In one embodiment, the present invention would first translate the reading frame to regenerate the amino acid sequence for the first entry in the database corresponding to the marginally identified reference sequence. Then, the invention would introduce the non-random chemical mutations or statistically weighted variations chosen by the user into the nucleotide sequence. If the resulting virtual nucleotide sequence variation changes the amino acid coding, one embodiment of the present invention could then generate the resulting virtual amino acid sequences for output. Since the available search programs process each amino sequence entry by executing a virtual enzyme digestion to produce peptides, the native amino acid sequence from the database known sequence surrounding the variation is extended in both directions to produce the virtual amino acid sequences, and can be FASTA formatted such that description lines are generated for each virtual sequence to precisely describe the variation.

One advantage of the current invention is that it may provide statistically weighted virtual variations which can be combined to create a database of virtual entries. Moreover, the smaller, more biologically relevant virtual database entries permit and facilitate study of multiple variations without generating enormous databases. By using known mutation patterns, the present invention can generate lists of peptide sequences that are more likely to occur in nature compared to other strategies. This is vastly more useful than randomly varying sequences or assuming all variations are equally likely, which generate sequences that are not likely to occur in nature and needlessly occupy computer processor time.

Thus, systems and methods in accordance with the present invention further permit the improvement of statistically marginal protein identifications generated by automated database searching programs that are based on few and/or low quality spectral matches to sequences available in database accessions. The invention provides novel candidate sequences with virtual variations for resubmitting searches against the MS/MS datafiles using existing automated searching programs. The resulting virtual amino acid sequences may be engineered to provide search programs with a novel set of peptides that are statistically or evolutionarily favorable potential matches with the unknown samples (MS/MS datafiles). Therefore, at a definable success rate, the present invention can provide novel identifications that have the potential to rescue otherwise marginal and unconvincing data.

Systems and methods in accordance with the present invention may also permit the determination of whether a DNA, RNA, or amino acid sequence in a pathogenic virus or a bacterial strain is the result of natural mutation or deliberate genetic engineering. The mutation and/or evolutionary fixation frequencies used to generate virtual mutations or evolutionary fixations by mutations rely on natural nucleotide mutation or fixation patterns. Conversely, variations imposed by genetic engineering (human intervention) are unlikely to correspond to or match with sequences generated by the present invention. Comparison of nucleotide or protein sequences from new pathogenic viral and bacterial strains or potential genetically engineered food protein from a plant or animal against virtual database entries generated by the present invention can be used as an indicator for the presence of unexpected sequences that do not match the natural mutation/fixation patterns. Taxa specific tables for mutation/fixation rates, such as scoring matricies, can also be used to help statistically “rank” the likelihood of a given observed in a newly observed pathogenic species. In short, because the novel, virtual database utilizes statistically and evolutionarily documented substitution patterns to predict novel sequences, any DNA, RNA, or amino acid sequences that differ significantly from these patterns may be recognized as genetically engineered. Unlike naturally-occurring proteins, genetically engineered sequences are manmade to achieve specific goals, with no consideration for adherence to naturally occurring mutation patterns.

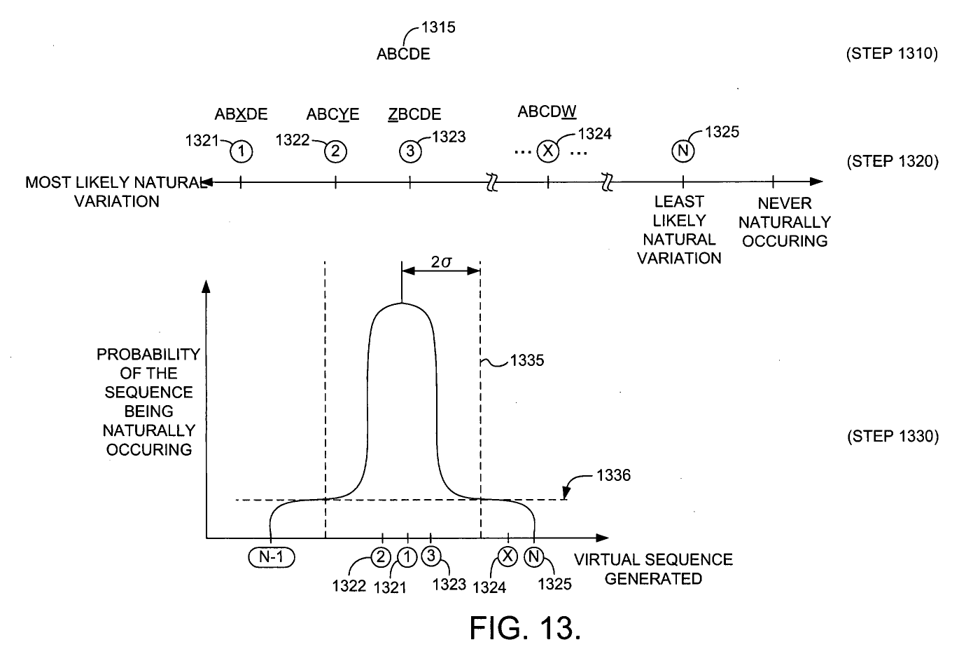

In one embodiment of the present invention directed toward detecting genetic engineering, an example of which is depicted in FIG. 13, the virtual database entries generated by the present invention can be combined with other virtual sequences and/or known sequences. This new database thus contains known entries and their variations that are most likely to occur naturally. Likewise, in the event a scoring matrix is utilized to generate virtual database entries, the virtual database entries can be statistically weighted to reflect the relative probabilities of finding the virtual sequences in nature. In an embodiment of the present invention, a user may input a portion of a known sequence 1315, as shown in a generic manner in step 1310. The present invention may generate virtual sequences 1321, 1322, 1323, 1324, 1325 (also shown in FIG. 13 in a generic manner, with variations underlined) from a known sequence 1315. The collection of database entries can be statistically weighted by some probability/frequency distribution determined by the variation inflected and/or by the scoring matrix and ranked from the most likely variation to the least likely variation, as depicted in step 1320. The user can then set parameters such that an observed sequence or sub-sequence will be deemed genetically engineered if it falls below a threshold probability 1335 of occurring naturally. One common threshold set by users is that of two standard deviations (2σ). Under that threshold assumption depicted in FIG. 13 by way of example only, if an observed sequence (not pictured) is found in the virtual database but is so rarely observed in nature such that it is not within the threshold probability 1335 (here, 2σ of the probability/frequency distribution), the invention will indicate that the sequence is likely genetically engineered, as is shown in step 1030. Virtual sequence x 1325 is one example of such a genetically engineered sequence because sequence x 1325 falls outside of the user determined threshold probability 1335. Of course, the pre-determined threshold is user-definable and need not be 2σ. Indeed, a user may also choose an fixed numeric threshold probability 1336, as opposed to a threshold probability determined from a distribution 1335, if the user so desires.

This kind of analysis can be used to assist in the distinction and recognition of genetically engineered pathogenic strains, agricultural varieties, or any other organism. For nucleotide sequences, the invention simply does not need to translate the virtually mutated nucleotide sequence after imposing the virtual sequence variation.

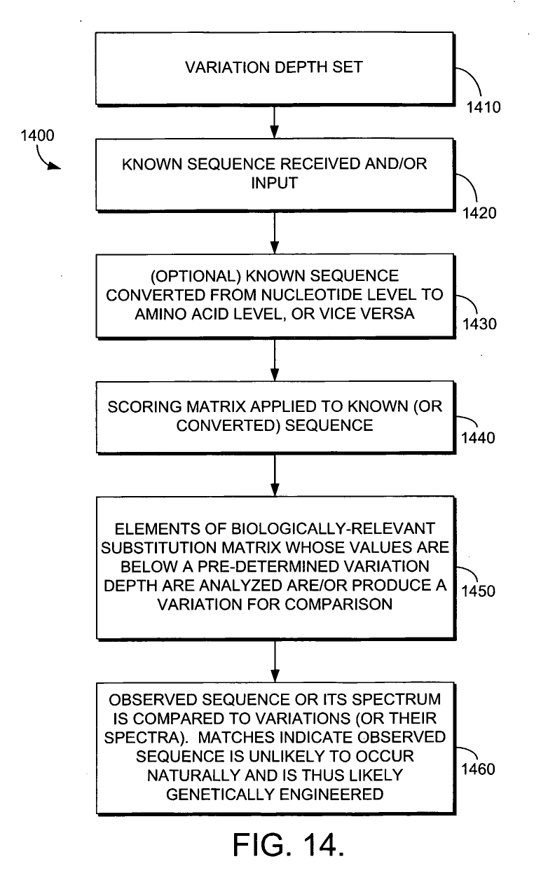

In another embodiment of the present invention directed toward detecting genetic engineering, one example of which is depicted in FIG. 14, a user may apply the current invention to an unknown, observed sequence, as in method 1400. In preparation, a user of the present invention may select a variation depth, as is shown in step 1410. A user may input or otherwise incorporate a known sequence, as shown in step 1420, that is believed to be similar to the observed sequence. Optionally, the present invention can convert the known sequence from the nucleotide level to the amino acid level or vice versa, step 1430, as appropriate. Step 1440 shows one way in which the present invention can selectively apply a biologically relevant substitution or scoring matrix to the known sequence such that the invention selects only those variations that are unlikely to occur naturally. A user of the present invention may choose to exclude variations of the known sequence that are likely to be found in nature through a user-selectable variation depth, step 1450, which could allow a user to search only against variations that are unlikely to occur naturally. As step 1460 illustrates, matching the observed, unknown sequence to a variation of the known sequence that is unlikely to occur naturally could indicate the presence of genetically engineered material.

Systems and methods in accordance with the present invention further permit the prediction of novel variations that may be pathogenic in diseased individuals. When a protein is considered as a candidate for pathogenicity, the identification of mutations can assist in the assessment of pathogenicity. If comparison of MS/MS data from a patient to a virtual database results in the identification of a new variation, the conservation of the amino acid position in related protein can be reviewed to assess potential structural/functional impairment, the underlying DNA mutation can be identified, and studies can be undertaken to determine the movement of this potential “marker” with disease. Such “linkage studies” are the analytical standard for identifying markers that follow a disease. The present invention predicts these with no a priori knowledge of the potential pathogenicity, so that novel pathogenic mutations may be discovered.

Systems and methods in accordance with the present invention also may further increase confidence in the identification of proteins from unusual or understudied organisms. Distant species have divergent protein sequences and evolutionary fixations or substitutions. The identification of proteins from underrepresented species poses a particularly difficult identification problem because a significant amount of the sequences differ from those existing in databases. The selective application of the current invention to divergent species offers a way to generate relevant sequences that occur in the underrepresented species. In this embodiment, all known nucleotide or amino acid sequences from the organism and selected evolutionary-related species can be used to generate substitution matrices, which in turn generate statistically and evolutionarily likely virtual sequences for comparison to MS/MS data.

While the instant invention has been shown and described herein, one skilled in the art will recognize that departures may be made from the embodiments disclosed herein that still fall within the scope of the invention. Accordingly, the invention is not limited to the details disclosed herein, but is to be afforded the full scope of the claims so as to embrace any and all equivalent system or method.

What is claimed is:

1. A method for generating virtual variations or virtual amino acid sequences informed by mutation or evolutionary fixation frequency information, the method comprising: receiving at least a portion of a known amino acid sequence; identifying a possible nucleotide sequence coding for the known amino acid sequence; for the identified possible nucleotide sequence, determining a non-random, statistically-weighted nucleotide variation; creating a virtual nucleotide sequence from the non-random, statistically-weighted nucleotide variation; and for the virtual nucleotide sequence, determining a virtual amino acid sequence coded for by the virtual nucleotide sequence, the virtual amino acid sequence suitable for comparison to data describing an amino acid sequence.

2. A method for generating virtual variations or virtual amino acid sequences informed by mutation or evolutionary fixation frequency information as set forth in claim 1, further comprising: identifying a virtual endoproteinase cleavage location for the virtual amino acid sequence, the virtual cleavage location forming an endpoint of a virtual sub-sequence of the virtual amino acid sequence, the virtual sub-sequence suitable for comparison to data describing sub-sequences of an observed amino acid sequence.

3. A method for generating virtual variations or virtual amino acid sequences informed by mutation or evolutionary fixation frequency information as set forth in claim 2, further comprising: identifying virtual fragments of the virtual sub-sequence, the virtual fragments suitable for comparison to observed mass spectrometry data.

4. A method for generating virtual variations or virtual amino acid sequences informed by mutation or evolutionary fixation frequency information as set forth in claim 1, wherein: the non-random, statistically-weighted nucleotide variation is further determined utilizing a scoring matrix.

5. A method for generating virtual variations or virtual amino acid sequences informed by mutation or evolutionary fixation frequency information, the method comprising: receiving at least a portion of a known amino acid sequence; determining a non-random, statistically-weighted amino acid variation; and creating a virtual amino acid sequence from the non-random, statistically-weighted amino acid variation, the virtual amino acid sequence suitable for comparison to data describing an observed amino acid sequence.

6. A method for generating virtual variations or virtual amino acid sequences informed by mutation or evolutionary fixation frequency information as set forth in claim 5, further comprising: identifying a virtual endoproteinase cleavage location for the virtual amino acid sequence, the virtual cleavage location forming an endpoint of a virtual sub-sequence of the virtual amino acid sequence, the virtual sub-sequence suitable for comparison to data describing sub-sequences of an observed amino acid sequence.

7. A method for generating virtual variations or virtual amino acid sequences informed by mutation or evolutionary fixation frequency information as set forth in claim 6, further comprising: identifying virtual fragments of the virtual sub-sequence, the virtual fragments suitable for comparison to observed mass spectrometry data.

8. A method for generating virtual variations or virtual amino acid sequences informed by mutation or evolutionary fixation frequency information as set forth in claim 5, wherein: the non-random, statistically-weighted variation is further determined utilizing a scoring matrix.

9. A method for generating virtual variations or virtual amino acid sequences informed by mutation or evolutionary fixation frequency information, the method comprising: receiving at least a portion of a known nucleotide sequence; determining a non-random, statistically-weighted nucleotide variation; creating a virtual nucleotide sequence from the non-random, statistically-weighted nucleotide variation; and for the virtual nucleotide sequence, determining a virtual amino acid sequence coded for by the virtual nucleotide sequence, the virtual amino acid sequence suitable for comparison to data describing an amino acid sequence.

10. A method for generating virtual variations or virtual amino acid sequences informed by mutation or evolutionary fixation frequency information as set forth in claim 9, further comprising: identifying a virtual endoproteinase cleavage location for the virtual amino acid sequence, the virtual cleavage location forming an endpoint of a virtual sub-sequence of the virtual amino acid sequence, the virtual sub-sequence suitable for comparison to data describing sub-sequences of an observed amino acid sequence.

11. A method for generating virtual variations or virtual amino acid sequences informed by mutation or evolutionary fixation frequency information as set forth in claim 10, further comprising: identifying virtual fragments of the virtual sub-sequence, the virtual fragments suitable for comparison to observed mass spectrometry data.

12. A method for generating virtual variations or virtual amino acid sequences informed by mutation or evolutionary fixation frequency information as set forth in claim 9, wherein: the non-random, statistically-weighted variation is further determined utilizing a scoring matrix.

13. A method for generating virtual variations or virtual amino acid sequences informed by mutation or evolutionary fixation frequency information, the method comprising: receiving at least a portion of a known nucleotide sequence; translating the known nucleotide sequence into the corresponding amino acid sequence; determining a non-random, statistically-weighted amino acid variation; and creating a virtual amino acid sequence from the non-random, statistically-weighted amino acid variation, the virtual amino acid sequence suitable for comparison to data describing an amino acid sequence.

14. A method for generating virtual variations or virtual amino acid sequences informed by mutation or evolutionary fixation frequency information as set forth in claim 13, further comprising: identifying a virtual endoproteinase cleavage location for the virtual amino acid sequence, the virtual cleavage location forming an endpoint of a virtual sub-sequence of the virtual amino acid sequence, the virtual sub-sequence suitable for comparison to data describing sub-sequences of an observed amino acid sequence.

15. A method for generating virtual variations or virtual amino acid sequences informed by mutation or evolutionary fixation frequency information as set forth in claim 14, further comprising: identifying virtual fragments of the virtual sub-sequence, the virtual fragments suitable for comparison to observed mass spectrometry data.

16. A method for generating virtual variations or virtual amino acid sequences informed by mutation or evolutionary fixation frequency information as set forth in claim 13, wherein: the non-random, statistically-weighted variation is further determined utilizing a scoring matrix.

17. A method for generating virtual variations or virtual amino acid sequences informed by mutation or evolutionary fixation frequency information for detection of genetically engineered sequences, the method comprising: receiving at least a portion of a known amino acid sequence; identifying a possible nucleotide sequence coding for the known amino acid sequence; for the identified possible nucleotide sequence, determining a non-random, statistically-weighted nucleotide variation; creating a virtual nucleotide sequence from the non-random, statistically-weighted nucleotide variation; and for the virtual nucleotide sequence, determining a virtual amino acid sequence coded for by the virtual nucleotide sequence, the virtual amino acid sequence suitable for comparison to data describing an amino acid sequence; combining data representing at least a portion of the virtual amino acid sequence with data representing similarly created portions of virtual amino acid sequences to form a collection of portions of virtual amino acid sequences; and determining that an observed sequence is likely genetically-engineered by comparing data representing the observed sequence to data representing the collection of virtual amino acid sequences to determine that the statistical likelihood of the observed sequence being naturally-occurring is below a pre-determined threshold.

18. A method for generating virtual variations or virtual amino acid sequences informed by mutation or evolutionary fixation frequency information for detection of genetically engineered sequences, the method comprising: receiving at least a portion of a known amino acid sequence; determining a non-random, statistically-weighted amino acid variation of the known amino acid sequence; creating a virtual amino acid sequence from the non-random, statistically-weighted amino acid variation, the virtual amino acid sequence suitable for comparison to data describing an observed amino acid sequence; combining data representing at least a portion of the virtual amino acid sequence with data representing similarly created portions of virtual amino acid sequences to form a collection of portions of virtual amino acid sequences; and determining that an observed sequence is likely genetically-engineered by comparing data representing the observed sequence to data representing the collection of virtual amino acid sequences to determine that the statistical likelihood of the observed sequence being naturally-occurring is below a pre-determined threshold.

19. A method for generating virtual variations or virtual amino acid sequences informed by mutation or evolutionary fixation frequency information for detection of genetically engineered sequences, the method comprising: receiving at least a portion of a known nucleotide sequence; determining a non-random, statistically-weighted nucleotide variation of the known nucleotide sequence; creating a virtual nucleotide sequence from the non-random, statistically-weighted nucleotide variation; for the virtual nucleotide sequence, determining a virtual amino acid sequence coded for by the virtual nucleotide sequence, the virtual amino acid sequence suitable for comparison to data describing an amino acid sequence; combining data representing at least a portion of the virtual amino acid sequence with data representing similarly created portions of virtual amino acid sequences to form a collection of portions of virtual amino acid sequences; and determining that an observed sequence is likely genetically-engineered by comparing data representing the observed sequence to data representing the collection of virtual amino acid sequences to determine that the statistical likelihood of the observed sequence being naturally-occurring is below a pre-determined threshold.

20. A method for generating virtual variations or virtual amino acid sequences informed by mutation or evolutionary fixation frequency information for detection of genetically engineered sequences, the method comprising: receiving at least a portion of a known nucleotide sequence; translating the known nucleotide sequence into the corresponding amino acid sequence; determining a non-random, statistically-weighted amino acid variation of the corresponding amino acid sequence; creating a virtual amino acid sequence from the non-random, statistically-weighted amino acid variation, the virtual amino acid sequence suitable for comparison to data describing an amino acid sequence; combining data representing at least a portion of the virtual amino acid sequence with data representing similarly created portions of virtual amino acid sequences to form a collection of portions of virtual amino acid sequences; and determining that an observed sequence is likely genetically-engineered by comparing data representing the observed sequence to data representing the collection of virtual amino acid sequences to determine that the statistical likelihood of the observed sequence being naturally-occurring is below a pre-determined threshold.

21. A system for generating virtual polymorphisms or virtual amino acid sequences, the system comprising: a source of data describing amino acid sequences that provides known amino acid sequences for analysis; an amino acid sequence data collector containing data describing a plurality of amino acid sequences; an amino acid sequence comparator coupled both to the source of known amino acid sequences and to the amino acid sequence data collector, the amino acid sequence comparator serving to identify matches of data describing a known amino acid sequence to data describing an amino acid in the amino acid sequence database, the amino acid sequence comparator further serving to identify the lack of a match of data describing a known amino acid to data describing amino acid sequences in the amino acid database; and a virtual amino acid sequence data generator, the virtual amino acid sequence data generator coupled to the amino acid sequence comparator, the virtual amino acid sequence data generator serving to generate non-random, statistically-weighted virtual amino acid sequences derived from amino acid sequences contained in the amino acid sequence database by inflicting a virtual amino acid variation using mutation frequency data or evolutionary weighting data; and wherein the amino acid sequence comparator further serves to identify matches of data describing a native amino acid sequence to data describing a virtual amino acid sequence generated by the virtual amino acid sequence generator.

22. The system of claim 21, further comprising: a virtual endoproteinase cleaver coupled to the virtual amino acid sequence data generator, the virtual endoproteinase cleaver serving to identify cleavage locations in the virtual amino acid sequence data based on the endoproteinase selected by the user, the virtual cleavage location forming an endpoint of a virtual amino acid sub-sequence, the virtual amino acid sub-sequence suitable for comparison to sub-sequences of an observed amino acid sequence.

23. The system of claim 22, wherein: the amino acid sequence comparator can compare a virtual amino acid sub-sequence to data derived from mass spectrometry.

24. The system of claim 23, wherein: the virtual amino acid sequence data generator utilizes a scoring matrix.

25. A method for detection of genetically engineered sequences, the method comprising: receiving at least a portion of a known amino acid sequence; identifying a possible nucleotide sequence coding for the known amino acid sequence; for the identified possible nucleotide sequence, utilizing a scoring matrix to identify a non-random, statistically-weighted nucleotide variation that is below a pre-determined variation depth; determining that an observed sequence is likely genetically engineered by matching data representing the observed sequence to data representing the nucleotide variation that is below a pre-determined variation depth.

26. A method for detection of genetically engineered sequences, the method comprising: receiving at least a portion of a known amino acid sequence; for the known amino acid sequence, utilizing a scoring matrix to identify a non-random, statistically-weighted amino acid variation of the known amino acid sequence that is below a pre-determined variation depth; determining that an observed sequence is likely genetically engineered by matching data representing the observed sequence to data representing the amino acid variation that is below a pre-determined variation depth.

27. A method for detection of genetically engineered sequences, the method comprising: receiving at least a portion of a known nucleotide sequence; for the known nucleotide sequence, utilizing a scoring matrix to identify a non-random, statistically-weighted nucleotide variation that is below a pre-determined variation depth; determining that an observed sequence is likely genetically engineered by matching data representing the observed sequence to data representing the nucleotide variation that is below a pre-determined variation depth.

28. A method for detection of genetically engineered sequences, the method comprising: receiving at least a portion of a known nucleotide sequence; translating the known nucleotide sequence into the corresponding amino acid sequence; for the corresponding amino acid sequence, utilizing a scoring matrix to identify a non-random, statistically-weighted amino acid variation that is below a pre-determined variation depth; determining that an observed sequence is likely genetically engineered by matching data representing the observed sequence to data representing the amino acid variation that is below a pre-determined variation depth.

29. A computer readable media containing embodied thereon computer readable code for causing a computer to perform a method for generating virtual variations or virtual amino acid sequences informed by mutation or evolutionary fixation frequency information, the method comprising: receiving at least a portion of a known amino acid sequence; identifying a possible nucleotide sequence coding for the known amino acid sequence; for the identified possible nucleotide sequence, determining a non-random, statistically-weighted nucleotide variation; creating a virtual nucleotide sequence from the non-random, statistically-weighted nucleotide variation; and for the virtual nucleotide sequence, determining a virtual amino acid sequence coded for by the virtual nucleotide sequence, the virtual amino acid sequence suitable for comparison to data describing an amino acid sequence.

30. A computer readable media containing embodied thereon computer readable code for causing a computer to perform a method for generating virtual variations or virtual amino acid sequences informed by mutation or evolutionary fixation frequency information, the method comprising: receiving at least a portion of a known amino acid sequence; determining a non-random, statistically-weighted amino acid variation of the known amino acid sequence; and creating a virtual amino acid sequence from the non-random, statistically-weighted amino acid variation, the virtual amino acid sequence suitable for comparison to data describing an observed amino acid sequence.

31. A computer readable media containing embodied thereon computer readable code for causing a computer to perform a method for generating virtual variations or virtual amino acid sequences informed by mutation or evolutionary fixation frequency information, the method comprising: receiving at least a portion of a known nucleotide sequence; determining a non-random, statistically-weighted nucleotide variation of the known nucleotide sequence; creating a virtual nucleotide sequence from the non-random, statistically-weighted nucleotide variation; and for the virtual nucleotide sequence, determining a virtual amino acid sequence coded for by the virtual nucleotide sequence, the virtual amino acid sequence suitable for comparison to data describing an amino acid sequence.

32. A computer readable media containing embodied thereon computer readable code for causing a computer to perform a method for generating virtual variations or virtual amino acid sequences informed by mutation or evolutionary fixation frequency information, the method comprising: receiving at least a portion of a known nucleotide sequence; translating the known nucleotide sequence into the corresponding amino acid sequence; determining a non-random, statistically-weighted amino acid variation; and creating a virtual amino acid sequence from the non-random, statistically-weighted amino acid variation, the virtual amino acid sequence suitable for comparison to data describing an amino acid sequence.
